(19) United States
(12) Patent Application Publication
(10) Pub. No.: US 2012/0142526 A1
(43) Pub. Date: Jun. 7, 2012

(54) METHOD FOR PRODUCING A CERAMIC FOAM HAVING REINFORCED MECHANICAL STRENGTH FOR USE AS A SUBSTRATE FOR A CATALYST BED

(75) Inventors: Pascal Del-Gallo, Dourdan (FR); Daniel Gray, Montigny Le Bretonneux (FR)

(73) Assignee: L'Air Liquide Societe Anonyme Pour L'Etude Et I'Exploitation Des Procedes Georges Claude, Paris (FR)

(21) Appl. No.: 13/389,537

(22) PCT Filed: Jul. 15, 2010
(86) PCT No.: PCT/FR2010/051482

§ 371 Date: Feb. 8, 2012

(30) Foreign Application Priority Data
Aug. 10, 2009 (FR) 0955602

(51) Int. Cl. B01J 21/04; B01J 21/10; B01J 23/10; B01J 21/06; B01J 32/00; B01J 37/08

(52) U.S. Cl. 502/439

(57) ABSTRACT

A method for manufacturing ceramic foam, including impregnating polymer foam having an open porosity with a first suspension of ceramic particles in a solvent; drying the impregnated polymer foam; heat treating the dried polymer foam by thermally decomposing the dried polymer foam; unbinding the organic compounds contained in the polymer foam, and pre-sintering the ceramic particles contained in the polymer foam; impregnating the polymer foam with a second suspension of ceramic particles in a solvent; drying the polymer foam, sintering the ceramic particles contained in the polymer foam.

The present invention relates to a controlled ceramic cellular architecture of enhanced mechanical strength, for example of the foam type, to its production process and to its use as catalyst support in the field of heterogeneous catalyst reactions.

The invention proposes a novel method of manufacturing a controlled cellular architecture, for example of the ceramic foam type, for enhancing the mechanical properties thereof while still maintaining an open-pore structure (macroporosity).

The expression “open-pore structure” is understood to mean a structure exhibiting maximum accessibility for fluids to enter the structure. In other words, the content of open pores (in this case cells) is a maximum, namely more than 95% of these pores are not obstructed, and therefore open.

The most widely used method of producing ceramic foams of open macroporosity consists in impregnating a polymer foam (usually a polyurethane or polyester foam), cut to the desired geometry, with a suspension of ceramic particles in an aqueous or organic solvent. The excess suspension is removed from the polymer foam by repeatedly applying pressure or by centrifugation, so as to maintain only a thin film of suspension on the polymer strands. After one or more impregnations of the polymer foam by this process, the foam is dried so as to remove the solvent, while maintaining the mechanical integrity of the ceramnic powder layer deposited. The foam is then heated to high temperature in two steps. The first step, called the organics removal step, consists in degrading the polymer and other organic compounds possibly present in the suspension, by a controlled slow temperature rise until the volatile substances have been completely removed (typically at 500-900° C.). The second step, called the sintering step, consists in consolidating the residual mineral structure by a high-temperature heat treatment. This manufacturing method thus makes it possible to obtain an inorganic foam which is the replica of the initial polymer foam apart from the sintering shrinkage. The final porosity permitted by this method covers a range from 30% to 95% for a pore size ranging from 0.2 mm to 5 mm. The final pore (or open macroporosity) size is dependent on the macrostructure of the initial organic “template” (a polymer, generally polyurethane, foam). This generally varies from 60 to 5 ppi (ppi: pores per inch) or 50 μm to 5 mm.

Other methods for manufacturing ceramic foams exist. For example, it is possible to introduce porosity into a ceramic part by adding a second phase, called a pore former, to the ceramic powder, which poreformer is degradable during sintering. However, this method does not make it possible to achieve high porosity levels (>85%) and a large pore size (>1 mm). Direct production of a foam by emulsifying a ceramic suspension using surfactants does result in structures having a very high pore volume (up to 97%) while maintaining high mechanical properties. However, the difficulty remains in how to control the size and distribution of the porosity with this method. The maximum pore size is also smaller than that permitted using a polymer foam impregnation technique.

Production of a foam having a high pore volume (>80%) and a large pore size (>1 mm) is thus facilitated by using the process described above for replicating a polymer foam. In addition, this manufacturing method is distinguished from the other methods by its ease of implementation and the ability to control the macroporosity over a wide size and pore volume range.

The major drawback of the polymer foam replication method lies in the presence of a cavity at the core of the ceramic foam at the site of the initial polymer. This cavity, which preserves the typical triangular shape of the strands of polymer foams, is very often surrounded by microcracks and other microstructural defects such as, for example, porosity. The presence of these defects considerably reduces the mechanical properties of ceramic foams.

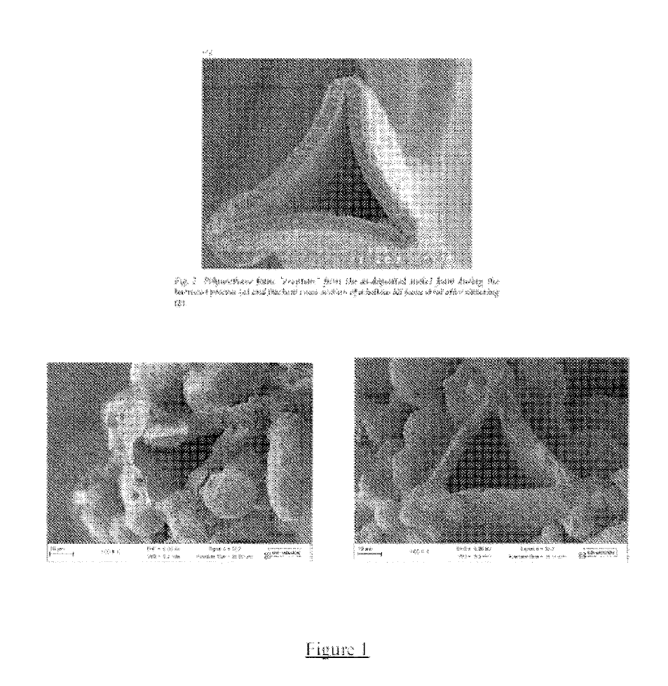

FIG. 1 illustrates, in the context of metal foams based on Ni or based on NiFeCrAlO obtained by impregnating a polymer foam, the presence of the triangular shape of the foam with a metal strand core.

Document U.S. Pat. No. 4,610,832 claims the use of a mineral binder (hydrated alumina) in the initial ceramic suspension in order to promote the sintering of the ceramic foam and improve its mechanical properties. This method does not act on the porosity of the strands.

Document EP 0 369 098 describes the reinforcement of a preexisting ceramic foam by a colloidal silica suspension under a vacuum followed by a further heat treatment. A very small part of the silica reaches right into the cavity of the foam strands, and the deposited layer may be cracked owing to the difference in expansion coefficient between said layer and the material constituting the foam.

Document U.S. Pat. No. 6,635,339 B1 proposes a method of reinforcing the strands of a ceramic foam by partially or completely filling the defects (pores, cracks, cavities) in the strands. A suspension of a metal phase, a glass or a ceramic is deposited on the foam before or after sintering. The final heat treatment is carried out at a temperature melting the deposited phase (metal, glass or ceramic), while the ceramic foam remains intact. The molten phase partially or completely fills the cavities of the strands. The difficulty of this method is choosing the material supplied, which has to have the same expansion coefficient as the foam and must not react too strongly therewith. Another drawback is that the maximum use temperature of the foam, especially as a catalyst support, is greatly reduced by the use of the meltable phase.

A scientific article by Han, Y.-s., et al., The effect of sintering temperatures on alumina foam strength. Ceramics International, 2002. 28(7), pp. 755-759 mentions the possibility of increasing the mechanical strength of ceramic foams by controlling the sintering temperature. The increase in mechanical strength here is directly caused by the densification of the ceramic structure, which increases with the sintering temperature. The optimum is achieved when the sintering shrinkage is a maximum and the ceramic microstructure is completely densified. A heat treatment at a higher temperature or for a longer time may possibly have the consequence of slightly lowering the mechanical strength, if the grain size increases for example. This approach is well known in ceramic processes and the sintering temperatures and times are generally chosen so to allow complete densification of the microstructure without causing grain coarsening.

Document EP 1 735 122 B1 manufacturing an Ni-based metal foam mentions an additional impregnation of a solution before or after the first heat treatment, which contains metals enabling the cavities formed (cores of the structure) to be filled by capillary action.

With this approach, one problem that arises is how to provide a ceramic cellular architecture of controlled macroporosity having enhanced mechanical strength.

One solution of the invention is a process for manufacturing a ceramic foam, comprising the following steps:

a) a first impregnation step, in which an open-pore polymer foam is impregnated with a first suspension of ceramic particles in a solvent;
b) a first drying step, in which the impregnated polymer foam is dried at a temperature between room temperature and 200° C. and/or for a time of between 30 minutes and 24 hours;
c) a heat treatment of the dried polymer foam, comprising:
(i) a step of thermally decomposing the dried polymer foam at a temperature between 150 and 700° C. and/or for a time of between 30 minutes and 48 hours,
(ii) a step of removing the organic compounds contained in the polymer foam after step (i), at a temperature between 200 and 900° C. and/or for a time of between 30 minutes and 48 hours; and
(iii) a step of presintering the ceramic particles contained in the polymer foam after step (ii), at a temperature of between 900 and 1400° C. and/or for a time of between 30 minutes and 6 hours;
   d) a second impregnation step, in which the polymer foam after step c) is impregnated with a second suspension of ceramic particles in a solvent;
   e) a second drying step for drying the polymer foam impregnated in step d); and
   f) a step of sintering the ceramic particles contained in the polymer foam dried in step e), at a temperature between 1200 and 2000° C. and/or for a time of between 30 minutes and 6 hours.

“Time” is understood to mean the time associated with the temperature rise and the temperature hold of the rise. In the case of the removal and drying steps, the temperature rises may be very slow (0.1° C./min), hence a very long time, while the temperature hold is only 1 to 2 hours.

The term “room temperature” is understood to mean the temperature of the ambient air, generally between 18 and 25° C.

Various polymeric materials may be used in step a), such as polyurethane (PU), polyvinyl chloride (PVC), polystyrene (PS), polyethylene (PE), cellulose and latices, but the ideal choice of the foam is limited by severe requirements. If the process does not involve immersion, the polymer foam must be elastic enough to recover its initial shape without irreversible deformation after having been compressed during the impregnation process. The polymer foam must have at least a few hydrophobic/hydrophilic interactions with the solvent of the suspension. The polymeric material must not release toxic compounds; PVC for example is avoided as it may cause hydrogen chloride to be released.

Polyurethane foams with a wide porosity range are available at low cost. In addition, they may be deformed and resume their initial shape after impregnation. Various types of polyurethane exist, called polyether urethanes, polyester urethanes and polyether ester urethanes, depending on the nature of the side chain of the polyol polymerized with the isocyanate. Even if the polymer is generally hydrophobic, the side chains of the polymer have hydrophilic (ester) properties or hydrophobic (ether) properties. It should be noted that polyurethane may cause NOx to be released.

With the exception of polystyrene foams, no other foams are commercially available, and polystyrene is not good enough to be compressed during the impregnation step.

The suspension of ceramic particles typically consists of ceramic particles, solvent and additives. The suspension must be sufficiently fluid to impregnate the polymer foam, but it must be sufficiently viscous to be retained on the polymer foam. The ceramic particles must be uniformly dispersed in the suspension. The size of the particles must be fine enough to promote the sintering process.

To improve the formulation of the suspension, additives (dispersants, binders, wetting agents, flocculating agents) may be used. These additives may be added:

for stabilization of the suspension;
for uniform coating of the foam;
for better adhesion of the suspension, etc.

The first impregnation step serves to cover the strands of the polymer foam with a uniform coating of the suspension, while preserving the open-pore structure of the foam.

The first drying step serves to remove the solvent.

The thermal decomposition step serves to burn off the polymer matrix.

The organics removal step serves to remove the volatile substances, including the polymer foam and the organic additives introduced into the suspension.

The presintering step serves to give the material sufficient mechanical strength to be handled, while still preserving a minimally densified microstructure.

The purpose of the second impregnation step is to deposit, on and in the hollow ceramic strands, a new filler of mineral material.

The second drying step serves to remove the solvent.

The sintering step serves to complete the heat treatment.

Preferably, the organics removal step and the first heat treatment are carried out in succession without intermediate handling of the foam.

Depending on the case, the process according to the invention may have one or more of the features mentioned below:

the ceramic particles of the first suspension are of the same nature as the ceramic particles of the second suspension;
the second suspension has a lower viscosity than the first suspension;
the size of the ceramic particles of the second suspension is smaller than the size of the ceramic particles of the first suspension;
the second impregnation step is carried out under a vacuum,
The three abovementioned features make it easy to insert the second suspension into the hollows of the ceramic strands. Specifically, it is necessary to have a highly fluid suspension, with a low mineral content and with a small initial particle size so as to be able for them to be inserted into the slits present after the presintering. The fact of then using a vacuum promotes this diffusion. The second impregnation step consists in filling the hollows of the strands, and therefore in eventually improving the mechanical properties;
the ceramic particles of the first and second suspensions are chosen from alumina (Al₂O₃) and/or doped alumina (La(1 to 20 wt %)-Al₂O₃, Ce-(1 to 20 wt %)-Al₂O₃ or Zr(1 to 20 wt %)-Al₂O₃), magnesia (MgO), a spinel (MgAl₂O₄), hydrotalcite, CaO, zinc oxide, cordierite, mullite, aluminum titanate, silicocalcareous compounds (SiₓCa_{y}O_{z}), silicoaluminous compounds (SiₓAl_{y}O_{z}), CaO—Al₂O₃ bases, carbides and nitrates, and zircon (ZrSiO4);
the ceramic particles of the first and second suspensions are chosen from ceria (CeO₂), zirconium (ZrO₂), stabilized ceria (between 3 and 10 mol % Gd₂O₃ in ceria) and stabilized zirconium (between 3 and 10 mol % Y₂O₃ in zirconium) and mixed oxides of formula (I):

Ce₍₁₋ₓ₎ Zrₓ O_{(2-δ)} (I),

where 0<x<1 and δ ensures electrical neutrality of the oxide, or doped mixed oxides of formula (II):

Ce_{(1-x-y)} Zrₓ D_{y} O_{2-δ} (II),

where D is chosen from magnesium (Mg), yttrium (Y), strontium (Sr), lanthanum (La), praseodymium (Pr), samarium (Sm), gadolinium (Gd), erbium (Er) and ytterbium (Yb), where 0<x<1, 0<y<0.5 and δ ensures electrical neutrality of the oxide.

Another subject of the present invention is a ceramic foam that can be obtained by a process according to the invention, having a porosity of between 10 and 90% and pore size of between 2 and 60 ppi (pores per inch), characterized in that said foam has strands at least partly filled with the ceramic particles of the second suspension.

The strands of the foam are preferably filled to more than 50%, more preferably to more than 80%.

The ceramic foams obtained by the process according to the invention have higher mechanical properties than foams produced according to the conventional process and a significantly lower amount of microstructural defects (pores, cracks, etc.) than foams produced under the same conditions using the conventional process.

The ceramic foams according to the invention may especially be used as catalyst support in heterogeneous catalysis.

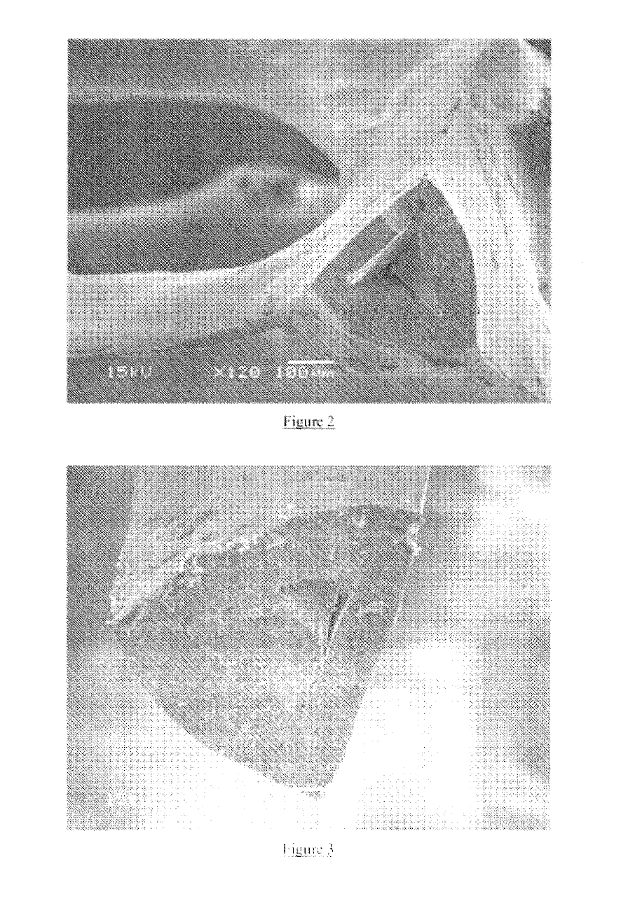

FIG. 2 is a micrograph produced by scanning electron microscopy with a magnification of ×120 of an alumina foam produced by a conventional impregnation method. It illustrates the presence of a triangular cavity in all the strands, which corresponds to the imprint left by the replicated polymer foam.

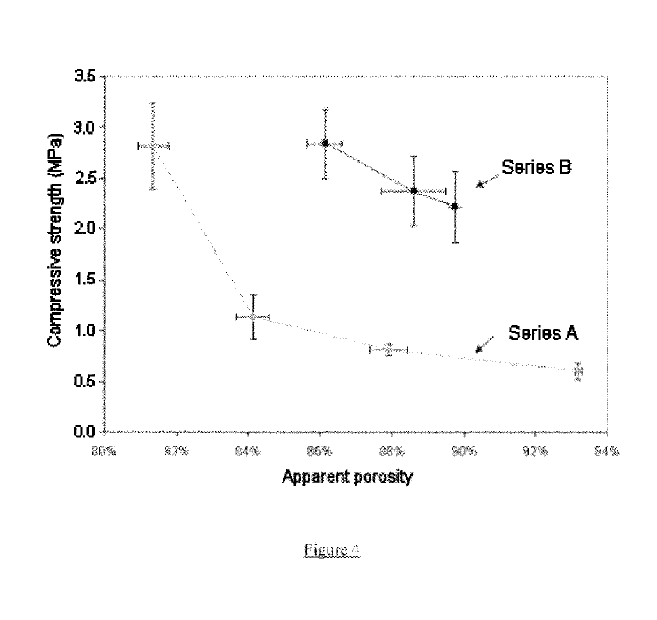

FIG. 3 is a micrograph produced by scanning electron microscopy with a magnification of ×250 of an alumina foam produced by the process according to the invention. It illustrates the microstructural modification of the strands, which are partially or completely filled with the impregnation phase that occurs after presintering.

FIG. 4 is a graph showing the variation in mechanical strength (mean and standard deviation) of two series of foams as a function of their apparent porosity. Series A corresponds to the production of alumina foams by the conventional protocol illustrated by FIG. 1. Series B corresponds to the production of alumina foams by the process according to the invention and illustrated above by FIG. 2. Apart from this difference, the sintering temperatures of the two series and other operating parameters are strictly identical.

This increase in the mechanical properties of the foam does not take place to the detriment of:

the refractoriness of the foam by employing material that melts at low or high temperature;
the intrinsic property of the main material constituting the foam by the use of one or more filler materials;
the retention of the high open-pore volume; and
the maintenance of a low pressure drop.

Moreover, this increase in the mechanical properties does not necessarily take place by using a chemical phase different from the main constituent material of the foam.

The invention will be described in greater detail in examples 1 to 3.

### EXAMPLE 1

A ceramic suspension (suspension A) was obtained by mixing an alumina powder of fine particle size (d₅₀<1 μm) with demineralized water, with an acrylic binder and with an ammonium polyacrylate used as dispersant for the alumina. The proportion by volume of the mineral phase was 30-40 vol % and that of the binder 5-10 vol %.

The suspension was used to impregnate a cylinder of polyurethane foam of 50 mm diameter and 50 mm height with a porosity of 10 ppi. The polyurethane strands were homogeneously coated with the suspension by repeatedly applying compression, either manually or using a two-roll machine with an adjustable nip. The excess suspension was removed until the mass of the foam covered with the suspension was 24 g. The foam was dried in an oven and then placed in a furnace where it was subjected to a heat treatment comprising a temperature rise from ambient temperature to 600° C. over 26 hours, then a second temperature rise from 600° C. to 1250° C. over 8 hours followed by a temperature hold at 1250° C. for 30 minutes (called the presintering step).

After cooling, the foam was white, with no polyurethane residue, and its mechanical strength was sufficient to be easily handled. A new suspension (suspension B) was used to cover the foam with a new alumina layer either by an immersion method or by a casting method. Suspension B was produced by diluting suspension A, its filler content being brought to 15-25 vol %.

After a further drying phase, the foam was placed in a furnace where it underwent a heat treatment at 1560° C. for 1 hour (called the sintering step).

The compressive strength of the foam thus produced was 2.2 MPa±0.3 MPa for a 90% porosity and a linear pressure drop of 6000-8000 Pa/m (air, 3 m/s, 20° C.). For comparison, a foam produced according to a conventional protocol not using the partial sintering step and the second impregnation step had a compressive strength of 0.8 MPa±0.2 MPa for an 88% porosity.

### EXAMPLE 2

A ceramic suspension (suspension A) was obtained by mixing an alumina powder of fine particle size (d₅₀<1 μm) with demineralized water, with an acrylic binder and with an ammonium polyacrylate used as dispersant for the alumina. The proportion by volume of the mineral phase was 30-40 vol % and that of the binder 5-10 vol %.

The suspension was used to impregnate a cylinder of polyurethane foam of 50 mm diameter and 50 mm height with a porosity of 10 ppi. The polyurethane strands were homogeneously coated with the suspension by repeatedly applying compression, either manually or using a two-roll machine with an adjustable nip. The excess suspension was removed until the mass of the foam covered with the suspension was 26 g. The foam was dried in an oven and then placed in a furnace where it was subjected to a heat treatment (thermal decomposition of the polymer matrix+organics removal+presintering) comprising a temperature rise from ambient temperature to 600° C. over 26 hours (partial thermal decomposition+partial organics removal), then a second temperature rise from 600° C. to 1200° C. over 8 hours (total organics removal+total thermal decomposition) followed by a temperature hold at 1200° C. for 30 minutes (presintering).

After cooling, the foam was white, with no polyurethane residue, and its mechanical strength was sufficient to be easily handled. A new suspension (suspension B) was used to cover the foam with a new alumina layer either by an immersion method or by a casting method. Suspension B was produced by diluting suspension A, its filler content being brought to 15-25 vol %.

After a further drying phase, the foam was placed in a furnace where it underwent a heat treatment at 1630° C. for 1 hour (sintering).

The compressive strength of the foam thus produced was 3.8 MPa±0.6 MPa for an 87% porosity.

### EXAMPLE 3

A ceramic suspension (suspension A) was obtained by mixing an alumina powder of fine particle size (d₅₀<1 μm) with demineralized water, with an acrylic binder and with an ammonium polyacrylate used as dispersant for the alumina. The proportion by volume of the mineral phase was 30-40 vol % and that of the binder 5-10 vol %.

The suspension was used to impregnate a cylinder of polyurethane foam of 50 mm diameter and 50 mm height with a porosity of 5 ppi. The polyurethane strands were homogeneously coated with the suspension by repeatedly applying compression, either manually or using a two-roll machine with an adjustable nip. The excess suspension was removed until the mass of the foam covered with the suspension was 31 g. The foam was dried in an oven and then placed in a furnace where it was subjected to a heat treatment (thermal decomposition+organics removal+presintering) comprising a temperature rise from ambient temperature to 600° C. over 26 hours, then a second temperature rise from 600° C. to 1250° C. over 8 hours followed by a temperature hold at 1250° C. for 30 minutes.

After cooling, the foam was white, with no polyurethane residue, and its mechanical strength was sufficient to be easily handled. A new suspension (suspension B) was used to cover the foam with a new alumina layer either by an immersion method or by a casting method. Suspension B was produced by diluting suspension A, its filler content being brought to 15-25 vol %.

After a further drying phase, the foam was placed in a furnace where it underwent a heat treatment at 1560° C. for 1 hour (sintering).

The compressive strength of the foam thus produced was 1.4 MPa±0.4 MPa for an 87% porosity and a linear pressure drop of 3000-5000 Pa/m (air, 3 m/s, 20° C.).

1-9. (canceled)

10. A process for manufacturing a ceramic foam, comprising the following steps:
a) impregnating an open-pore polymer foam with a first suspension of ceramic particles in a solvent, in a first impregnation step;
b) drying the impregnated polymer foam at a temperature between room temperature and 200° C. and/or for a time of between 30 minutes and 24 hours, in a first drying step;
c) heat treating the dried polymer foam, the heat treating comprising:
(i) thermally decomposing the dried polymer foam at a temperature between 150 and 700° C. and/or for a time of between 30 minutes and 48 hours, in a thermal decomposition step,
(ii) removing the organic compounds contained in the polymer foam after step (i), at a temperature between 200 and 900° C. and/or for a time of between 30 minutes and 48 hours, in a removal step; and
(iii) presintering the ceramic particles contained in the polymer foam after step (ii), at a temperature of between 900 and 1400° C. and/or for a time of between 30 minutes and 6 hours, in a presintering step;
d) impregnating the polymer foam after step c) with a second suspension of ceramic particles in a solvent, in a second impregnation step;
e) drying the polymer foam impregnated in step d), in a second drying step; and
f) sintering the ceramic particles contained in the polymer foam dried in step e), at a temperature between 1200 and 2000° C. and/or for a time of between 30 minutes and 6 hours, the size of the ceramic particles of the second suspension being smaller than the size of the ceramic particles of the first suspension, in a second sintering step.

11. The manufacturing process of claim 1, wherein the ceramic particles of the first suspension are of the same nature as the ceramic particles of the second suspension.

12. The manufacturing process of claim 1, wherein the second suspension has a lower viscosity than the first suspension.

13. The manufacturing process of claim 1, wherein the second impregnation step is carried out under a vacuum.

14. The manufacturing process of claim 1, wherein the ceramic particles of the first and second suspensions are chosen from the group consisting of alumina (Al₂O₃) doped alumina (La(1 to 20 wt %)-Al₂O₃, Ce-(1 to 20 wt %)-Al₂O₃ or Zr(1 to 20 wt %)-Al₂O₃), magnesia (MgO), a spinel (MgAl₂O₄), hydrotalcite, CaO, zinc oxide, cordierite, mullite, aluminum titanate, silicocalcareous compounds (SiₓCa_{y}O_{z}), silicoaluminous compounds (SiₓAl_{y}O_{z}), CaO—Al₂O₃ bases, carbides and nitrates, and zircon (ZrSiO4).

15. The process of claim 1, wherein the ceramic particles of the first and second suspensions are chosen from the group consisting of ceria (CeO₂), zirconium (ZrO₂), stabilized ceria (between 3 and 10 mol % Gd₂O₃ in ceria) and stabilized zirconium (between 3 and 10 mol % Y₂O₃ in zirconium) and mixed oxides of formula (I):
Ce₍₁₋ₓ₎ Zrₓ O_{(2-δ)} (I),
where 0<x<1 and δ ensures electrical neutrality of the oxide, or doped mixed oxides of formula (II):
Ce_{(1-x-y)} Zrₓ D_{y} O_{2-δ} (II),
where D is chosen from magnesium (Mg), yttrium (Y), strontium (Sr), lanthanum (La), praseodymium (Pr), samarium (Sm), gadolinium (Gd), erbium (Er) and ytterbium (Yb), where 0<x<1, 0<y<0.5 and δ ensures electrical neutrality of the oxide.

16. A ceramic foam that can be obtained by a process of claim 1, having a porosity of between 10 and 90% and pore size of between 2 and 60 ppi, wherein said foam has strands at least partly filled with the ceramic particles of the second suspension.

17. The ceramic foam of claim 16, wherein the strands are filled to more than 80%.

18. The use of a ceramic foam of claim 16, as catalyst support in heterogeneous catalysis.
